(19) United States
(12) Patent Application Publication
(10) Pub. No.: US 2024/0168932 A1
(43) Pub. Date: May 23, 2024

(54) System and Method for Integrated Multiple Pluggable Systems

(71) Applicant: International Business Machines Corporation, Armonk, NY (US)

(72) Inventors: Ying Mo, Beijing (CN); Jian Huang, Beijing (CN); Guangya Liu, Xian (CN); Hou Fang Zhao, Beijing (CN); Zhi Li, Beijing (CN); Xiaoli Duan, Beijing (CN); Yan Wei Li, Beijing (CN)

(73) Assignee: International Business Machines Corporation, Armonk, NY (US)

(21) Appl. No.: 17/989,310

(22) Filed: Nov. 17, 2022

(51) Int. Cl. G06F 16/22; G06F 8/38; G06F 16/21

(52) U.S. Cl. CPC G06F 16/22; G06F 8/38; G06F 16/211

(57) ABSTRACT

A method for storing metadata and a configuration schema for each of a plurality of capabilities, and storing a plurality of catalogs, each catalog identifying the metadata and configuration schema associated with at least one of the plurality of capabilities. The method also includes receiving a request for implementation of one of the plurality of capabilities on a pluggable system, and associating, by a lifecycle manager and based on a catalog of the plurality of catalogs related to the request, the metadata and configuration schema related to the requested one of the plurality of capabilities with a domain specific capabilities controller compatible with the pluggable system.

### BACKGROUND

The present disclosure relates generally to pluggable systems and, more particularly, to a system and method for integrated multiple pluggable systems.

Many modern software systems, such as cloud-based and other systems, are designed as pluggable architecture. Plugins are software components created by developers that provide specific capabilities to the systems that support pluggable architecture. In turn, users implement the plugins based on a need for the functionality and capability provided by the plugins.

### SUMMARY

A method that includes storing metadata and a configuration schema for each of a plurality of capabilities. The method includes storing a plurality of catalogs, each catalog identifying the metadata and configuration schema associated with at least one of the plurality of capabilities. The method further includes receiving a request for implementation of one of the plurality of capabilities on a pluggable system, and associating, by a lifecycle manager and based on a catalog of the plurality of catalogs related to the request, the metadata and configuration schema related to the requested one of the plurality of capabilities with a domain specific capabilities controller compatible with the pluggable system.

A system for computing that includes a non-transitory computer-readable storage memory configured to store instructions. The system further including a processor coupled to the non-transitory computer-readable storage memory and configured to execute the instructions to cause the system to store metadata and a configuration schema for each of a plurality of capabilities and further to store a plurality of catalogs, each catalog identifying the metadata and configuration schema associated with at least one of the plurality of capabilities. The system further configured to execute the instructions to cause the system to receive a request for implementation of one of the plurality of capabilities on a pluggable system, and associate, by a lifecycle manager and based on a catalog of the plurality of catalogs related to the request, the metadata and configuration schema related to the requested one of the plurality of capabilities with a domain specific capabilities controller compatible with the pluggable system.

A computer program product for computing. The computer program product comprising instructions stored on a non-transitory computer-readable medium that, when executed by a processor, cause a system to store metadata and a configuration schema for each of a plurality of capabilities, and further to store a plurality of catalogs, each catalog identifying the metadata and configuration schema associated with at least one of the plurality of capabilities. The computer program product when executed by a processor, cause the system to receive a request for implementation of one of the plurality of capabilities on a pluggable system, and associate, by a lifecycle manager and based on a catalog of the plurality of catalogs related to the request, the metadata and configuration schema related to the requested one of the plurality of capabilities with a domain specific capabilities controller compatible with the pluggable system.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustration of a system for integrated multiple pluggable systems in accordance with aspects of the present disclosure.

FIG. 2 is a block diagram illustration of ancillary data of the system in accordance with aspects of the present disclosure.

FIG. 3 is a block diagram illustration of request data of the system in accordance with aspects of the present disclosure.

FIG. 4 is a block diagram illustration of a system for integrated multiple pluggable systems in accordance with aspects of the present disclosure.

FIG. 5 is a flowchart illustration of a method in accordance with aspects of the present disclosure.

FIG. 6 is a block diagram illustration of a hardware architecture of a data processing system in accordance with aspects of the present disclosure.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” (and inflections thereof) are used in an open-ended fashion, and thus should be interpreted to mean “including, but not limited to.” Unless otherwise indicated, as used throughout this document, “or” does not require mutual exclusivity, and the singular forms “a,” “an,” and “the” are intended to include the plural forms as well, unless the context clearly indicates otherwise.

A “module” or “unit” (and inflections thereof) as referenced herein comprises one or more hardware or electrical components such as electrical circuitry, processors, and memory that may be specially configured to perform a particular function. The memory may comprise volatile memory or non-volatile memory that stores data such as, but not limited to, computer executable instructions, machine code, and other various forms of data. The module or unit may be configured to use the data to execute one or more instructions to perform one or more tasks. In certain instances, a module or unit may also refer to a particular set of functions, software instructions, or circuitry that is configured to perform a specific task. For example, a module or unit may comprise software components such as, but not limited to, data access objects, service components, user interface components, application programming interface (API) components; hardware components such as electrical circuitry, processors, and memory; and/or a combination thereof. As referenced herein, computer executable instructions may be in any form including, but not limited to, machine code, assembly code, and high-level programming code written in any programming language.

Also, as used herein, the term “communicate” (and inflections thereof) means to receive and/or transmit data or information over a communication link. The communication link may include both wired and wireless links, and may comprise a direct link or may comprise multiple links passing through one or more communication networks or network devices such as, but not limited to, routers, firewalls, servers, and switches. The communication networks may comprise any type of wired or wireless network. The networks may include private networks and/or public networks such as the Internet. Additionally, in some embodiments, the term communicate may also encompass internal communication between various components of a system and/or with an external input/output device such as a keyboard or display device.

As noted above, developers, which may also be referred to herein as producers, may develop and distribute plugins for use by the pluggable systems. Users, which may also be referred to herein as consumers, may implement the plugins in systems with pluggable architecture based on the need for the capability provided by the plugins. However, the implementation of plugins and requirements for plugins to be compatible with pluggable systems may vary. For example, each pluggable system may have specific requirements for plugins compatibility, such as the programming language used to develop the plugin, as well as the manner in which the plugin is packaged and published to the pluggable system. Also, pluggable systems may differ in the way consumers implement the functionality of plugins, such as how consumers discover, install, upgrade, update, and uninstall pluggable capabilities.

In an embodiment, the present disclosure provides systems and methods integrated multiple pluggable systems and for managing the lifecycle for pluggable capabilities. In an exemplary embodiment, producers of plugins or pluggable capabilities may provide information, such as details of the developed plugin or capability in the form of metadata and configuration schemas. The producer may also provide a catalog that identifies the capability and the metadata and configuration schema related to a given capability. The consumer may specify information about one or more desired capabilities and the pluggable system in which the capability will be implemented. The present system includes a management tool including a catalog manger that organizes the catalogs of the provided capabilities and allows consumers to identify the desired capability. The management tool also includes a lifecycle manager that manages the configuration and implementation of the capability on the pluggable system based on the information provided by the producer about the capability, as well as, information provided by the consumer about desired configuration of the capability and the pluggable system in which it will operate.

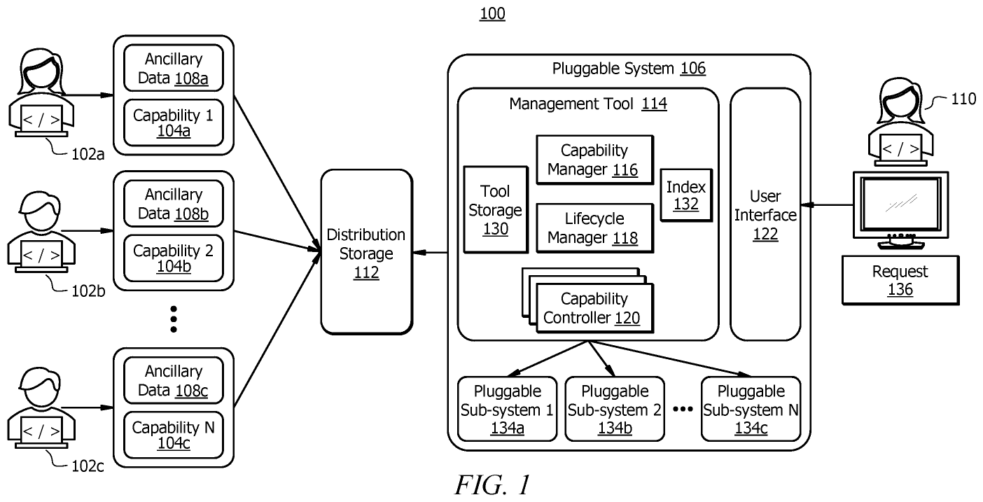

FIG. 1 is a block diagram illustration of a system 100 for integrated multiple pluggable systems and for managing the lifecycle for pluggable capabilities. Various components comprising the system 100 may operate as computer software or programs that when executed by computer processors perform the described functions and operations, all of which will be discussed in greater detail below.

As discussed above, computer software developers or producers 102, individually denoted as 102a-c, in may develop software plugins or capabilities 104, individually denoted as 104a-c, that may be implemented on systems having pluggable architecture to enable these systems with the desired capability 104. The capability 104 may be a cloud native plugin, such as for example, a binary file provided as a container image that includes the actual executable file or files, and any other files or formats used for providing plugin capabilities for pluggable systems. System 100 includes a pluggable system 106 with such pluggable architecture. The pluggable system 106 may be, for example, a cloud computing or cloud native architecture type system, such as the IBM Cloud Pak® or other cloud or computing systems.

While only a single pluggable system 106 is illustrated, the present disclosure contemplates operation of the present system 100 to simultaneously support any number of pluggable systems 106. To install, uninstall, and implement the capabilities 104 on the pluggable system 106, a given capability 104 may require specific configuration in order to be managed and configured to operate properly on the pluggable system 106. Accordingly, the producers 102 may provide various ancillary data 108, individually denoted as 108a-c, for each capability 104 that may be used by a user or consumer 110 desiring to implement a particular capability 104 on the pluggable system 106. The capabilities 104 and associated ancillary data 108 may be stored at various locations in a distribution storage 112. However, it may be difficult for the consumer 110 to identify a particular capability 104 and property manage the capability 104 on the pluggable system 106, particularly when the consumer 110 is managing numerous pluggable systems 106 each requiring different capabilities 104.

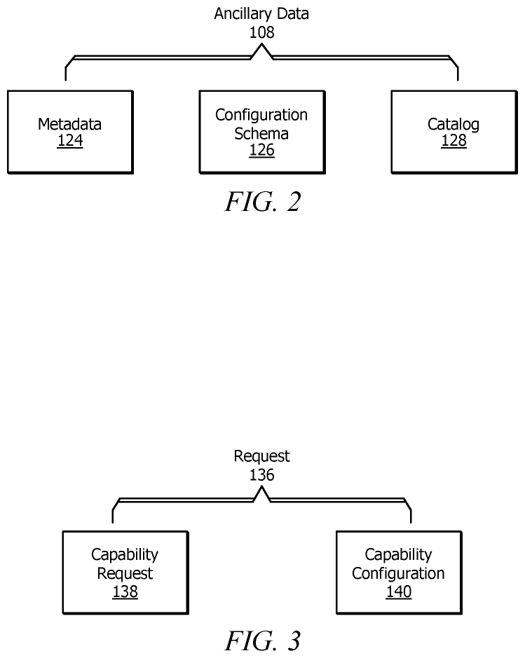

As illustrated in FIG. 2, the ancillary data 108 provided by the producer 102 about each capability 104 may include metadata 124, a configuration schema 126, and a catalog 128. In the illustrated embodiment, the metadata 124, the configuration schema 126, and the catalog 128 may be separate data files that contain the relevant information about the capability 104.

The metadata 124 may be a data file that includes data about the associated capability 104. The data about the capability 104 may include a location where the capability 104 is stored, a name or identifier of the capability 104, a list of keywords describing the capability 104 that may be used for searching or identifying the capability 104. The metadata 124 may include a version number, contact information of the producer 102 of the capability 104, and any other data describing the capability 104, which will readily suggest themselves to one skilled in the art in view of the present disclosure. In one embodiment, the producer 102 may provide metadata 124 for each capability 104. Further, where the producer 102 provides multiple versions of a particular capability 104, the producer 102 would provide metadata 124 and configuration schema 126 for each version of the capability 104.

The configuration schema 126 is also provided by the producer 102 and includes further details for configuring the associated capability 104. The configuration schema 126 may be a data file that includes the file type or types of the capability 104, information describing data fields, descriptions of the data fields, default values, and so on related to the implementation and operation of the capability 104. The configuration schema 126 may be used by the consumer 110 to customize the specific capability 104 for implementation on a particular pluggable system 106. In use, the configuration schema 126 may be used to provide the consumer 110 with prompts for input of such information to ensure compatibility and proper operation of the capability 104. In this embodiment, the producer 104 may provide the configuration schema 126 for each capability 104, and where the producer 102 provides multiple versions of a particular capability 104, the producer 102 may provide a separate configuration schema 126 for each version of the capability 104. The configuration schema 126, in some embodiments, may contain read-only data that is used for data validation to ensure correct, valid data is provided when making calls or requests, such as via an application programming interface or otherwise, to the capability 104.

The catalog 128 is also provided by the producer 102 and includes data identifying the capability 104 and the specific metadata 124 and configuration schema 126 associated with each capability 104. The catalog 128 may include other information about the capability 104, such as the pluggable system 106 or systems that are compatible with the capability 104 and other relevant information such as the location where the capability 104 and associated files are stored and may be retrieved. In some cases, producers 102 may develop multiple capabilities 104 that are similar, such as different versions of the same capability 104. In these instances, the catalog 128 for a particular capability 104 having multiple versions may contain the reference or association specifying the particular metadata 124 and configuration schema 126 for each particular version of the capability 104. Thus, the producer 102 may provide a single catalog 128 providing all the related information for multiple versions of a capability 104.

In some embodiments, it may be convenient for the metadata 124, configuration schema 126, and catalog 128 to each be provided in separate, individual data files. However, it is anticipated, in other embodiments, that the metadata 124, configuration schema 126, and catalog 128 may each be comprised of multiple data files or further that the relevant information may all be contained in single file or in a various combination of files.

Referring again to FIG. 1, the capabilities 104 and related ancillary data 108 discussed above may be stored in the distribution storage 112, which may include storage and distribution local to the consumer 110 or pluggable system 106 or sub-system, storage and distribution at remote storage locations, or storage local or remotely for packaged distribution.

The system 100 further includes a management tool 114 for lifecycle management of pluggable capabilities 104. The management tool 114 includes a catalog manager 116, a lifecycle manager 118, and capability controller 120. The management tool 114 is illustrated as part of the pluggable system 106 for simplicity of discussion. However, the present disclosure is not so limited and also contemplates implementations where the management tool 114 is provided and executed on other systems and merely accessed by the producers 102 and consumer 110 in actual operation. In some embodiments, the management tool 114 may also include a user interface 122, such as a web-based user interface, to enable consumers 110 to access the features of the management tool 114. The management tool 114 and the various components may be stored in a tool storage 130 at various locations depending on the desired implementation, as discuss above. Further, in some embodiments, while not required, it may be useful to maintain the ancillary data 108 stored locally at the tool storage 130, such as local copies of the metadata 124, configuration schemas 126, and catalogs 128 for each capability 104, for ready access by the management tool 114.

The catalog manager 116 accesses the catalogs 128 associated with the various capabilities 104 and develops and maintains an index 132 or listing of all or most of the catalogs 128. The index 132 may include all or only certain portions of the information from each catalog 128. For example, the index 132 may include the name, location, and description for each capability 104 and the associated ancillary data 108, as well any other information useful to consumers 110 for identifying each capability 104. The index 132 is used by the catalog manager 116 to provide ready access to and mapping and locations of all the capabilities 104 and associated ancillary data 108. As new catalogs 128 and related capabilities 104 are added, removed, or modified by producers 102, the catalog manager 116 updates the index 132 accordingly.

The capability controllers 120 comprise a plurality of different domain specific controllers, adapters, and interfaces compatible with the various pluggable systems 106 or the pluggable sub-systems 134 of the pluggable system 106. As will be appreciated by one skilled in the art, installing, uninstalling, updating, and implementing the capabilities 104 on the pluggable systems 106 and pluggable sub-systems 134 is typically accomplished with such compatible capability controller 120. The capability controllers 120 may be stored in the tool storage 130 or elsewhere depending on the implementation. As used herein, the pluggable sub-system 134 may refer to the various systems and sub-systems that comprise the operation of the overall pluggable system 106 and thus the terms may be used interchangeably herein for convenience.

The lifecycle manager 118 coordinates with the catalog manager 116 and capability controllers 120 to manage and implement requests 136 from consumers 110 for the various capabilities 104. Referring also to FIG. 3, consumers 110 may provide the request 136 to the management tool 114 for a particular capability 104. The request 136 may include a capability request 138 and a capability configuration 140. The capability request 138 and the capability configuration 140 may be included in a single file, or in multiple separate files, as illustrated in this embodiment. The capability request 138 includes data detailing the requested capability 104 including the name or identifier of the requested capability 104 and version number and other relevant information. The capability configuration 140 includes the relevant data and values that correspond to the information identified in the configuration schema 126. For example, where a particular capability 104 requires certain data for operation as defined in the related configuration schema 126, the capability configuration 140 provides the data desired by the consumer 110 for specific configuration of that capability 104 on the pluggable sub-system 134. Thus, the consumer 110 provides a separate capability request 138 and capability configuration 140 for each specific capability 104 that the consumer 110 wants to implement on the pluggable sub-system 134. The capability configuration 140 may further include details about the target pluggable sub-system 134 and other data to enable the consumer 110 to customize the implementation of the capability 104 on that target sub-system 134.

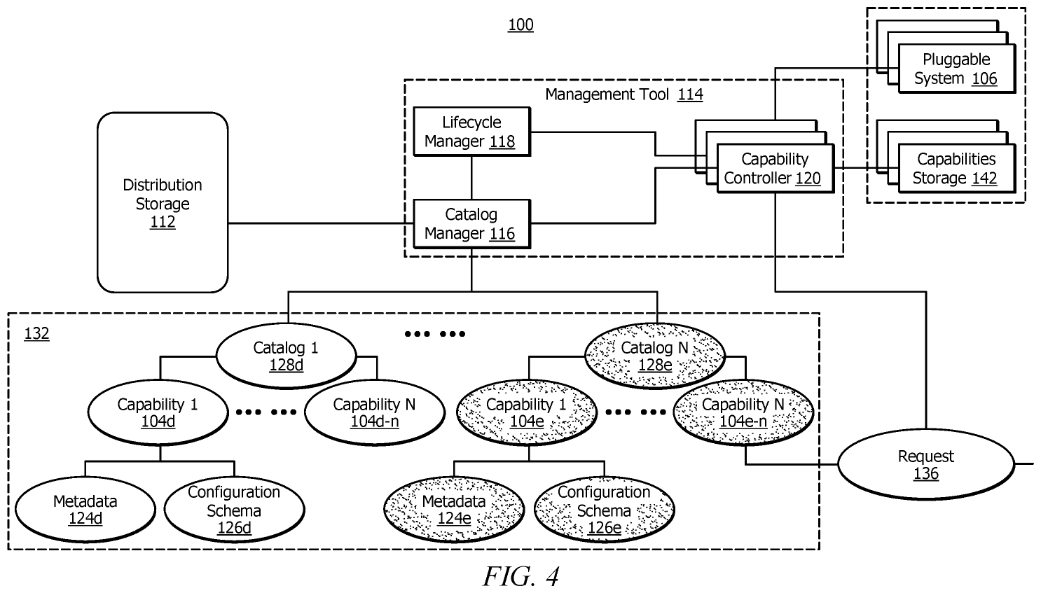

FIG. 4 illustrates another embodiment of the system 100. In this view, the index 132 is illustrated as a logical arrangement of the various catalogs 128 (individually denoted as 128d-e), capabilities 104 (individually denoted as 104d-e), and associated metadata 124 (individually denoted as 124d-e) and configuration schemas 126 (individually denoted as 126d-e) related to each capability 104. Also in this view, the pluggable system 106 is shown separately but in communication with the management tool 114. The pluggable system 106 is also shown with an associated capabilities storage 142 where the various capabilities 104 may be downloaded and stored for ready access by the pluggable sub-systems 134.

The consumer 110 may access the management tool 114, via the user interface 122 shown in FIG. 1. As mentioned above, the user interface 122 may be a web-based or other interface for accessing the functionality provided by the management tool 114. The lifecycle manager 118 may operate in coordination with the catalog manager 116 to assist the consumer 110 in identifying specific capabilities 104 desired by the consumer 110. For example, the consumer 110 may input details or descriptions about specific capabilities 104 into the user interface 122 and the catalog manager 116 may search and retrieve, via the index 132, details about relevant capabilities 104 and provide these details to the consumer 110, via the user interface 122. The consumer 110 may then use the retrieved details to identify the relevant metadata 124 and configuration schemes 126 for the capability 104 that the consumer 110 desires to implement on one of the various pluggable sub-systems 134.

In some embodiments, the consumer 110 may manually create the capability request 138 for the desired capability 104, along with the capability configuration 140 based on the configuration schema 126 associated with the desired capability 104. In other embodiments, the lifecycle manager 118 may read the associated configuration schema 126 and, via the user interface 122, prompt the consumer 110 to input the relevant data, values, and so on based on capability 104 requirements as specified in the associated configuration schema 126. The lifecycle manager 118 may perform data validation and other functions to assist the consumer 110 in this process. The lifecycle manager 118 may provide the information from by the consumer 110 in the form of the capability request 138 and capability configuration 140.

The consumer 110 may submit the request 136 with the details specified in the capability request 138 and capability configuration 140 to the lifecycle manager 118, via the user interface 122, to implement the request 136. In other embodiments, the consumer 110 may submit the request 136 via other methods, such as using an application programming interface, command line interface, or otherwise, for receipt by the lifecycle manager 118. Regardless of the method of receipt, the lifecycle manager 118 then processes the request 136.

Upon receipt of the request 136, the lifecycle manager 118 processes the request 136 from the consumer 110 using the data from the capability request 138 and compatibility configuration 140. Once the lifecycle manager 118 determines from the request 136 the requested capability 104 and specific configurations, the lifecycle manager 118 coordinates with the catalog manager 116 to obtain the relevant details, including locations and associations, of the capability 104 from the ancillary data 108, specifically the associated metadata 124 and configuration schema 126. The lifecycle manager 118 may perform real-time data validation on the request 136 to ensure that the details provided by the consumer 110 in the capability configuration 140 are valid based on the requirements defined in the configuration schema 126 provided by the producer 102. The lifecycle manager 118 may reject invalid requests 136 and the consumer 110 would need to make appropriate changes. Provided the lifecycle manager 118 validates the request 136, the lifecycle manager 118 uses information in request 136, along with the metadata 124 and configuration schema 126, to identify and coordinate the requested capability 104 with the compatible capability controller 120 based on the target pluggable sub-system 134 deploying the capability 104. As part of this coordination, the lifecycle manager 118 provides the relevant domain specific controller 120 with the location of the relevant files associated with the capability 104, such as binaries, container, and so on. The compatibility controller 120 then drives the implementation of the requested capability 104 on the target pluggable sub-system 134. Implementing the capability 104 may include installing, uninstalling, upgrading, or other operations involving the capability 104 with respect to the target pluggable sub-system 134.

When the consumer desires to change the behavior of a capability 104, such as uninstalling or upgrading to a new version of the capability 104 or customizing implementation of a capability 104, the consumer 110 may modify the information in the request 136 to specify the desired upgrade version. At runtime, the lifecycle manager 118 monitors each request and implements any changes identified in the request 136, such as installing or upgrading a new version of the capability 104 or customizing details of the implementation, substantially as discuss above. Thus, the management tool 114 enables implementation of capabilities dynamically and with without interrupting existing services operating on the pluggable system 106.

While embodiments have described one process for implementing requests 136 from consumers 110, the present disclosure anticipates embodiments where the consumer 110 may implement requested capability 104 entirely via the user interface 122 and the lifecycle manager 118 may seamlessly implement the capability 104, as otherwise described above.

As can be seen, management tool 114, via the lifecycle manager 118 and different domain specific capability controllers 120, provides a consistent interface regardless of the pluggable sub-system 134 where the capability 104 will be implemented. While the above discussion discloses implementation of a single capability 104 on a single pluggable sub-system 134, it will be appreciated that the management tool 114 enables any number of consumers 110 to interface with multiple, different pluggable sub-systems 134 and manage any numbers of capabilities 104 on those pluggable sub-systems 134.

Further, the present disclosure allows producers 102 to develop, package, and distribute capabilities 104 and the associated ancillary data 108 in a manner where consumers 110, via the management tool 114, can readily discover and configure capabilities for implementation on different pluggable systems 106 and pluggable sub-systems 134. In some embodiments, the structure provided by the present disclosure may reduce the extra development or coding otherwise necessary by the producer 102 to build composed or combinations of capabilities 104 for implementation on specific pluggable systems 106, and instead exposes each capability 104 to the consumer 110 so that that consumer 110, via the management tool 114, may implement any desired combinations of capabilities 104 on any pluggable system 106.

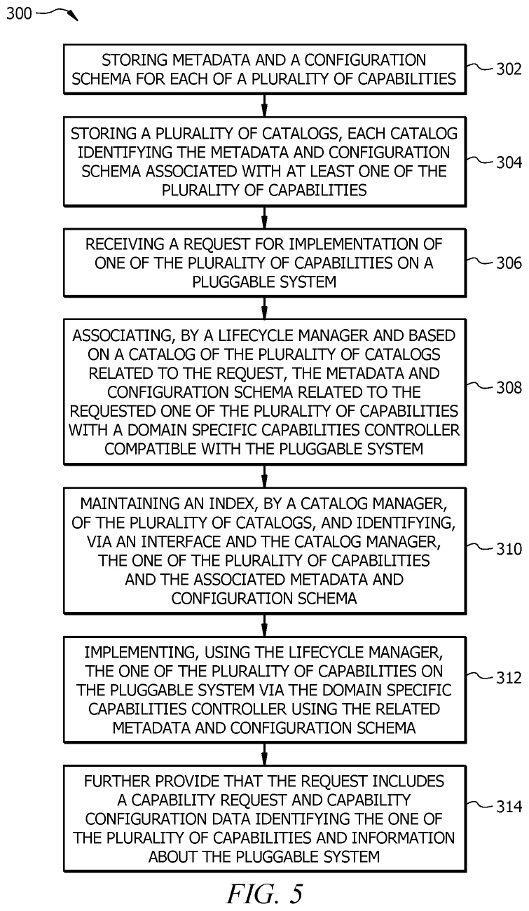

FIG. 5 is a flow diagram illustrating a method 300 according to an embodiment of the present disclosure. The method 300 includes, at block 302, storing metadata and a configuration schema for each of a plurality of capabilities. At block 304, the method 300 includes storing a plurality of catalogs, each catalog identifying the metadata and configuration schema associated with at least one of the plurality of capabilities. At block 306, the method 300 includes receiving a request for implementation of one of the plurality of capabilities on a pluggable system. The method 300, at block 308, includes associating, by a lifecycle manager and based on a catalog of the plurality of catalogs related to the request, the metadata and configuration schema related to the requested one of the plurality of capabilities with a domain specific capabilities controller compatible with the pluggable system. The method 300, at block 310 may further include maintaining an index, by a catalog manager, of the plurality of catalogs, and identifying, via an interface and the catalog manager, the one of the plurality of capabilities and the associated metadata and configuration schema. The method 300, at block 312, may further include implementing, using the lifecycle manager, the one of the plurality of capabilities on the pluggable system via the domain specific capabilities controller using the related metadata and configuration schema. The method 300, at block 314, may further provide that the request includes a capability request and capability configuration data identifying the one of the plurality of capabilities and information about the pluggable system, the method 300 further includes identifying, using the metadata and configuration schema associated with the one of the plurality of capabilities, a location of the one of the plurality of capabilities associated with the request, retrieving the one of the plurality of capabilities from the location based on the metadata and configuration schema associated with the request, and implementing the one of the plurality of capabilities on the pluggable system based on the capability request and capability configuration data.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

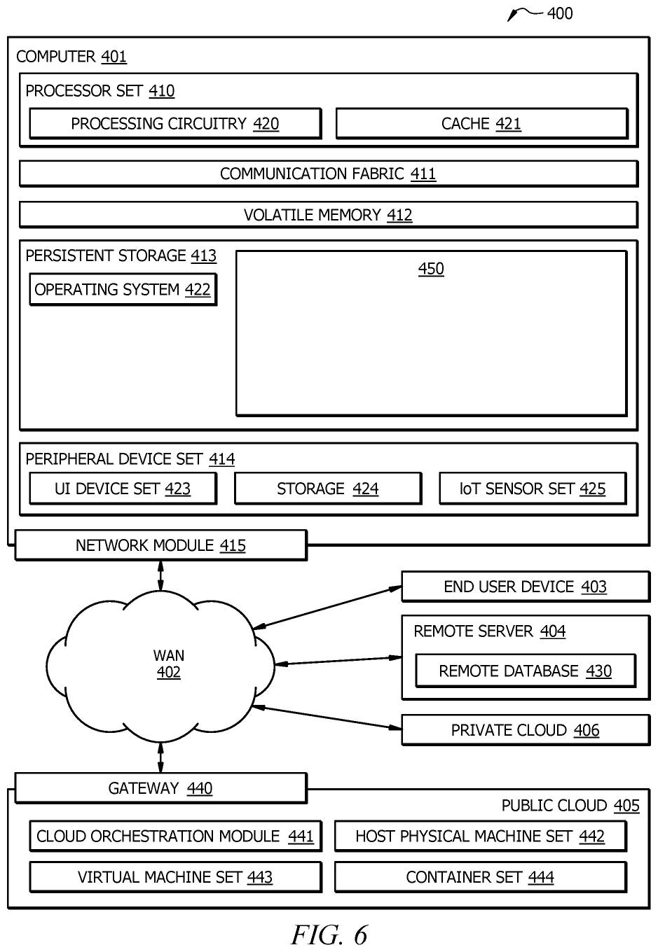

FIG. 6 is a block diagram illustration of a hardware architecture of a computing environment 400 in accordance with aspects of the present disclosure. Computing environment 400 contains an example of an environment for the execution of at least some of the computer code involved in performing the inventive methods, such as computing possibly optimal policies in reinforcement learning with multiple objectives and tradeoffs module 450. In addition to module 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and module 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in module 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in module 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, user interface (UI) device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. Internet of Things (IoT) sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
storing metadata and a configuration schema for each of a plurality of capabilities;
storing a plurality of catalogs, each catalog identifying the metadata and configuration schema associated with at least one of the plurality of capabilities;
receiving a request for implementation of one of the plurality of capabilities on a pluggable system; and
associating, by a lifecycle manager and based on a catalog of the plurality of catalogs related to the request, the metadata and configuration schema related to the requested one of the plurality of capabilities with a domain specific capabilities controller compatible with the pluggable system.

2. The method of claim 1, further comprising:
maintaining an index, by a catalog manager, of the plurality of catalogs; and
identifying, via an interface and the catalog manager, the one of the plurality of capabilities and the associated metadata and configuration schema.

3. The method of claim 2, wherein the interface is a user interface, an application programming interface, or a command line interpreter.

4. The method of claim 1, further comprising implementing, using the lifecycle manager, the one of the plurality of capabilities on the pluggable system via the domain specific capabilities controller using the related metadata and configuration schema.

5. The method of claim 4, wherein implementing the capability incudes installing, uninstalling, or upgrading the one of the plurality of capabilities on a pluggable system.

6. The method of claim 1, wherein the request includes a capability request and capability configuration data identifying the one of the plurality of capabilities and information about the pluggable system, and wherein the method further comprises:
identifying, using the metadata and configuration schema associated with the one of the plurality of capabilities, a location of the one of the plurality of capabilities associated with the request;
retrieving the one of the plurality of capabilities from the location based on the metadata and configuration schema associated with the request; and
implementing the one of the plurality of capabilities on the pluggable system based on the capability request and capability configuration data.

7. The method of claim 1, wherein a first and second capability of the plurality of capabilities relate, respectively, to a first and second version of a capability of the plurality of capabilities, and wherein each of the first and second capabilities associate with first and second metadata and configuration schemas, respectively, and wherein at least one of the plurality of catalogs identifies the first metadata and first configuration schema as associated with the first capability and the second metadata and second configuration schema as associated with the second capability.

8. A system, comprising:
a non-transitory computer-readable storage memory configured to store instructions; and
a processor coupled to the non-transitory computer-readable storage memory and configured to execute the instructions to cause the system to:
store metadata and a configuration schema for each of a plurality of capabilities;
store a plurality of catalogs, each catalog identifying the metadata and configuration schema associated with at least one of the plurality of capabilities;
receive a request for implementation of one of the plurality of capabilities on a pluggable system; and
associate, by a lifecycle manager and based on a catalog of the plurality of catalogs related to the request, the metadata and configuration schema related to the requested one of the plurality of capabilities with a domain specific capabilities controller compatible with the pluggable system.

9. The system of claim 8, wherein the processor is further configured to execute the instructions to:
maintain an index, by a catalog manager, of the plurality of catalogs; and
identify, via an interface and the catalog manager, the one of the plurality of capabilities and the associated metadata and configuration schema.

10. The system of claim 9, wherein the interface is a user interface, an application programming interface, or a command line interpreter.

11. The system of claim 8, wherein the processor is further configured to execute the instructions to implement, using the lifecycle manager, the one of the plurality of capabilities on the pluggable system via the domain specific capabilities controller using the related metadata and configuration schema.

12. The system of claim 11, wherein implementing the capability incudes installing, uninstalling, or upgrading the one of the plurality of capabilities on a pluggable system.

13. The system of claim 8, wherein the request includes a capability request and capability configuration data identifying the one of the plurality of capabilities and information about the pluggable system, and wherein the processor is further configured to execute the instructions to:
identify, using the metadata and configuration schema associated with the one of the plurality of capabilities, a location of the one of the plurality of capabilities associated with the request;
retrieve the one of the plurality of capabilities from the location based on the metadata and configuration schema associated with the request; and
implement the one of the plurality of capabilities on the pluggable system based on the capability request and capability configuration data.

14. The method of claim 8, wherein a first and second capability of the plurality of capabilities relate, respectively, to a first and second version of a capability of the plurality of capabilities, and wherein each of the first and second capabilities associate with first and second metadata and configuration schemas, respectively, and wherein at least one of the plurality of catalogs identifies the first metadata and first configuration schema as associated with the first capability and the second metadata and second configuration schema as associated with the second capability.

15. A computer program product comprising instructions stored on a non-transitory computer-readable medium that, when executed by a processor, cause a system to:
store metadata and a configuration schema for each of a plurality of capabilities;
store a plurality of catalogs, each catalog identifying the metadata and configuration schema associated with at least one of the plurality of capabilities;
receive a request for implementation of one of the plurality of capabilities on a pluggable system; and
associate, by a lifecycle manager and based on a catalog of the plurality of catalogs related to the request, the metadata and configuration schema related to the requested one of the plurality of capabilities with a domain specific capabilities controller compatible with the pluggable system.

16. The computer program product of claim 15, wherein the instructions further cause the system to:
maintain an index, by a catalog manager, of the plurality of catalogs; and
identify, via an interface and the catalog manager, the one of the plurality of capabilities and the associated metadata and configuration schema.

17. The computer program product of claim 16, wherein the interface is a user interface, an application programming interface, or a command line interpreter.

18. The computer program product of claim 15, wherein the instructions further cause the system to implement, using the lifecycle manager, the one of the plurality of capabilities on the pluggable system via the domain specific capabilities controller using the related metadata and configuration schema.

19. The computer program product of claim 18, wherein implementing the capability incudes installing, uninstalling, or upgrading the one of the plurality of capabilities on a pluggable system.

20. The computer program product of claim 1, wherein the request includes a capability request and capability configuration data identifying the one of the plurality of capabilities and information about the pluggable system, and wherein the instructions further cause the system to:
identify, using the metadata and configuration schema associated with the one of the plurality of capabilities, a location of the one of the plurality of capabilities associated with the request;
retrieve the one of the plurality of capabilities from the location based on the metadata and configuration schema associated with the request; and
implement the one of the plurality of capabilities on the pluggable system based on the capability request and capability configuration data.
